(19) United States
(12) Patent Application Publication
(10) Pub. No.: US 2023/0192501 A1
(43) Pub. Date: Jun. 22, 2023

(54) SILICON-BASED POWDERS AND METHOD FOR PRODUCING THE SAME

(71) Applicant: FORMOSA PLASTICS CORPORATION, Kaohsiung City (TW)

(72) Inventors: Wen-Bee KUO, Kaohsiung City (TW); Ming-Hung CHENG, Mailiao Township (TW); Wan-Tun HUNG, Kaohsiung City (TW); Yu-Cheng CHEN, Kaohsiung City (TW); Wen-Hung TSENG, Kaohsiung City (TW); Kuo-Ming HUANG, Kaohsiung City (TW); Wen-Chieh LAI, Kaohsiung City (TW); Shang-Shih LI, Kaohsiung City (TW); Wen-Yuan CHEN, Kaohsiung City (TW); Hsin TSENG, Kaohsiung City (TW); Hsun-Ku LEE, Tainan City (TW); Yu-Hsin CHEN, Tainan City (TW)

(21) Appl. No.: 18/082,714

(22) Filed: Dec. 16, 2022

(30) Foreign Application Priority Data
Dec. 16, 2021 (TW) 110147153

(51) Int. Cl. C01B 33/021

(52) U.S. Cl. CPC C01B 33/021; C01P 2006/11; C01P 2006/32

(57) ABSTRACT

The present invention relates to silicon-based powders and a method for producing the silicon-based powders. The method for producing the silicon-based powders includes a hydrolysis step of a silicon precursor having an alkoxy group, a condensation step and a drying step. By a specific weight ratio of water to the silicon precursor having the alkoxy group and a silicon precursor having a secondary amino group and an alkyl group, in the method for producing the silicon-based powders, the condensation step can be performed without organic solvents, and a modification on silicon-based gels can be performed to enhance a safety of processes and a hydrophobicity of the resulted silicon-based powders, and decrease a thermal conductivity and a bulk density of the resulted silicon-based powders.

### RELATED APPLICATION

This application claims priority to Taiwan Application Serial Number 110147153, filed on Dec. 16, 2021, which is herein incorporated by reference in its entirety.

### BACKGROUND

### Field of Invention

The present invention relates to silicon-based powders and a method for producing the same, and more particularly relates to the method for producing the silicon-based powders without organic solvents and the resulted silicon-based powders.

### Description of Related Art

Silicon-based powders are materials with a porous network structures, which have high porosity, high specific surface area and small pore diameter, and pores of the network structure are filled with gas (e.g. air), and therefore bulk density and thermal conductivity of the silicon-based powders are low, and the silicon-based powders can be used as a thermal insulation material. The conventional method for producing the silicon-based powders comprises a hydrolysis step, a condensation step and a drying step. In the condensation step, a silicon precursor and a basic catalyst are subjected to a condensation reaction in organic solvents. The organic solvents can make the silicon precursor to be dissolved (or dispersed) in a reaction system, and during the subsequent drying step, solvent-replacing is performed to remove water inside the pores. Since surface tension of the organic solvents is lower than that of water, the structure of the silicon-based powders is prevented from being destroyed by the water with a high surface tension during the drying step. However, when water is replaced with the organic solvents, a lot of organic gases are generated during the drying step, and thus it is necessary to recycle the organic solvents with the condensation step, which increases the risk, complexity and cost of the process.

Next, in the conventional method for producing the silicon-based powders, a basic catalyst is additionally used to catalyze the condensation, but the basic catalyst causes the condensation reaction to be too vigorous to lower dense properties of the structure of the resulted silicon-based powders, and thus a thermal conductivity and a bulk density of the silicon-based powders are increased.

Besides, a hydrophobicity of the resulted silicon-based powders is too poor to be used as a hydrophobic thermal insulation material. Therefore, in the conventional method for producing the silicon-based powders, a long-term surface modification step is additionally performed to modify hydrophobic groups on surfaces of the silicon-based gels, thereby enhancing the hydrophobicity of the resulted silicon-based powders.

In view of these, it is necessary to develop silicon-based powders and a method for producing the silicon-based powders to solve the aforementioned drawbacks of the conventional silicon-based powders and the method for producing the conventional silicon-based powders.

### SUMMARY

Accordingly, an aspect of the present invention is to provide a method for producing silicon-based powders. In the method, a specific silicon precursor having a secondary amino group and alkyl groups are chosen and a specific weight ratio of water to the silicon precursor is controlled to perform a condensation without organic solvents, thereby enhancing a safety of processes and a hydrophobicity of the silicon-based powders and decreasing a thermal conductivity and a bulk density of the silicon-based powders.

Another aspect of the present invention is to provide silicon-based powders. The silicon-based powders are produced by the aforementioned method for producing the silicon-based powders. The silicon-based powders have a high hydrophobicity, a low thermal conductivity and a low bulk density.

According to an aspect of the present invention, a method for producing the silicon-based powders is provided. In the method, a hydrolysis step is performed to a first silicon precursor, an emulsifier and water to obtain a hydrolyzed solution. Next, a preparing step is performed, in which a silicon precursor aqueous solution (i.e. the second silicon precursor aqueous solution described following) is prepared, the silicon precursor aqueous solution comprises a second silicon precursor and a diluted water. Afterwards, a condensation step is performed to the hydrolyzed solution and the second silicon precursor aqueous solution to obtain silicon-based gels. Then, a drying step is performed to the silicon-based gels obtain the silicon-based powders. All of the hydrolysis step, the preparing step and the condensation step exclude organic solvents.

According to one embodiment of the present invention, the first silicon precursor comprises a silicate compound and/or a silane compound. The silicate compound comprises silicate and/or ammonium silicate of alkali metals. The silane compound comprises a methyl silicone compound, and the methyl silicone compound is one or more compounds selected from a group consisting of methyltrimethoxysilane (MTMS), methyltriethoxysilane, dimethyldimethoxysilane, and dimethyldiethoxysilane.

According to another embodiment of the present invention, based on a weight of the first silicon precursor as 100 parts by weight, a weight of the emulsifier is 0.1 part by weight to 1 part by weight.

According to yet another embodiment of the present invention, the hydrolysis step is performed at a pH value of 2.5 to 4.0.

According to yet another embodiment of the present invention, the second silicon precursor comprises one or more compounds having a structure shown as following formula (I):

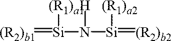

In the formula (I), R₁ is independently a hydrogen atom or an alkyl group having 1 to 4 carbons, R₂ independently is alkylene group having 1 to 4 carbons, and b1 and b2 are independently 0 or 1; when the b1 and the b2 both are 0, a1 and a2 both are 3; when the b1 and the b2 both are 1, the a1 and the a2 both are 1.

According to yet another embodiment of the present invention, the second silicon precursor is one or more compounds selected from a group consisting of tetraalkyl disilazane and hexaalkyl disilazane.

According to yet another embodiment of the present invention, a weight ratio of the first silicon precursor to the second silicon precursor is 1 : 0.005 to 1 : 0.05.

According to yet another embodiment of the present invention, a weight ratio of the diluted water to the first silicon precursor is more than 11.

According to yet another embodiment of the present invention, an initial pH value of the condensation step is more than 7 and less than 8.

According to yet another embodiment of the present invention, a pressure of the drying step is 0.5 atm to 1.5 atm, and a drying temperature of the drying step is 80° C. to 150° C.

According to another aspect of the present invention, silicon-based powders are provided. The silicon-based powders are produced by the aforementioned method for producing the silicon-based powders, in which a thermal conductivity coefficient of the silicon-based powders is less than 0.035 W/m·K, and a bulk density of the silicon-based powders is less than 0.05 g/cm³.

According to one embodiment of present invention, a contact angle of the silicon-based powders is more than 140 °.

In an application of the silicon-based powders and the method for producing the silicon-based powders of the present invention, in which by using the specific silicon precursor having the secondary amino group and the alkyl groups and adjusting of the specific weight ratio of water to the silicon precursor having the alkoxy, in the method, the condensation can be performed without organic solvents and the modification is performed to the silicon-based gels to enhance the safety of the processes and the hydrophobicity of the resulted silicon-based powders, and decrease the thermal conductivity and the bulk density of the resulted silicon-based powders.

### BRIEF DESCRIPTION OF THE DRAWINGS

Now please refer to description below and accompany with corresponding drawings to more fully understand embodiemnts of the present invention and advantages thereof. It has to be emphasized that all kinds of characteristics are not drawn in scale and olny for illustrative purpose. The description regarding to the drawings as follows:

FIG. 1 illustrates a flow chart of a method for producing silicon-based powders according to an embodiment of the present invention.

FIGS. 2A to 2C are electron micrographs of the silicon-based powders according to embodiments 1 to 3 of the present invention, respectively.

FIGS. 2D to 2F are electron micrographs of the silicon-based powders according to comparative embodiments 1 to 3 of the present invention, respectively.

### DETAILED DESCRIPTION

A manufacturing and usage of embodiments of the present invention are discussed in detail below. However, it could be understood that embodiments provide much applicable invention conception which can be implemented in various kind specific contents. The specific embodiments discussed are only for illustration, but not be a limitation of scope of the present invention.

In a method for producing silicon-based powders of the present invention, a hydrolysis is performed to monomers (i.e. the first silicon precursors described following) of the silicon-based powders and acids (i.e. the acid catalyst described following) to generate a first silanol compound. Further, the obtained hydrolyzed solution and a second silicon precursor aqueous solution are mixed, in which the acid catalyst can make the second silicon precursor hydrolyze to generate ammonia water and a second silanol compound. The generated ammonia water can facilitate the first silanol compound undergo a condensation. Due to a slow hydrolysis rate of the second silicon precursor, the ammonia water can be generated continuously in small amounts, and the generated ammonia water is greatly diluted with diluted water. Therefore, a pH value of a reaction system (i.e. a mixture of the hydrolyzed solution and the second silicon precursor aqueous solution) also increases slowly. The gradually increased pH value makes the condensation undergo slowly, and thus polysiloxane condensed by the first silanol compound can form particles with small and uniform sizes, the silicon-based gels with a three-dimensional network structure are formed by an aggregation (or stack) of these particles. The three-dimensional network structure has good denseness and a high porosity, and the integrity of the structure can be retained in a drying step, and thus a bulk density and a thermal conductivity coefficient of the resulted silicon-based powders are decreased.

The aforementioned second silanol compound has one silanol group and several alkyl groups, in which the silanol group can react with a silanol group on surfaces of the silicon-based gels, and these alkyl groups can enhance a hydrophobicity of the surfaces of the silicon-based gels. Once the surfaces of the silicon-based gels become hydrophobic, it is beneficial to remove water inside pores in the structure of the silicon-based gels, and the integrity of the structure can be retained (i.e. the three-dimensional network is formed). Therefore, in the method for producing the silicon-based powders of the present invention, it is not necessary to add organic solvents in the condensation step, the organic solvents facilitate the removal of water inside the pores in the condensation step, thereby enhancing a safety of processes, and decreasing a bulk density of the resulted silicon-based powders and a thermal conductivity coefficient thereof.

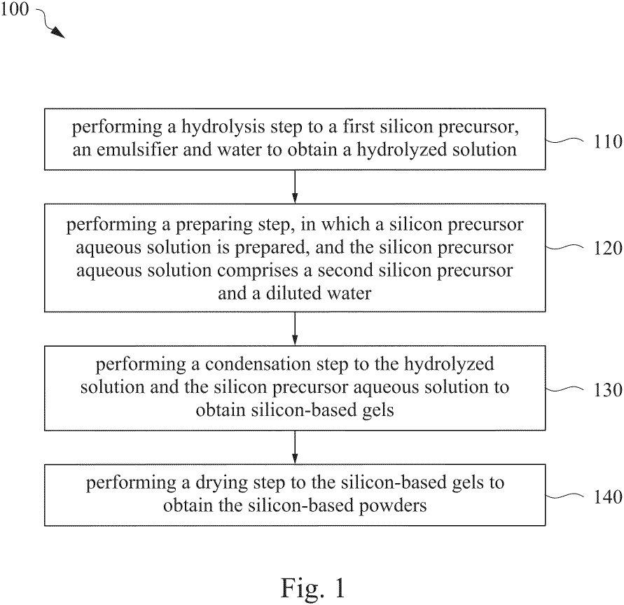

Referring to FIG. 1, in a method 100 for producing silicon-based powders, a hydrolysis step is first performed to a first silicon precursor, an emulsifier and water to obtain a hydrolyzed solution, as shown in an operation 110. In some embodiments, the first silicon precursor can comprise, but be not limited to, a silicate compound and/or a silane compound. Specific examples of the silicate compound can comprise, but be not limited to, silicate and/or ammonium silicate of alkali metals, such as potassium silicate, sodium silicate, lithium silicate and ammonium silicate. When the silicate compound described above is used as the first silicon precursor, the silicate compound can facilitate the polysiloxane particles aggregate (or stack) to form the silicon-based gels with the three-dimensional network structure, and thus the bulk density and the thermal conductivity coefficient of the resulted silicon-based powders are decreased.

In some specific examples, the silane compound can include, but be not limited to, methyl siloxane compound. Preferably, the methyl siloxane compound is one or more compounds selected from a group consisting of methyltrimethoxysilane, methyltriethoxysilane, dimethyldimethoxysilane, and dimethyldiethoxysilane. When the silane compound described above is used as the first silicon precursor, a silanol compound generated by the hydrolysis has three silanol groups and one lower alkyl group, and thus it is beneficial to produce the silicon-based gels with the three-dimensional network structure and the high porosity.

Specific examples of the emulsifier can include, but be not limited to, cetyltrimethylammonium bromide (CTAB), dodecyl trimethyl ammonium bromide (DTAB), and cetyltrimethylammonium chloride (CTAC). In some embodiments, based on a weight of the first silicon precursor as 100 parts by weight, a weight of the emulsifier is 0.1 part by weight to 1 part by weight. When the weight of the emulsifier is in the aforementioned range, the emulsifier is enough to emulate the first silicon precursor, such that the first silicon precursor can be dissolved (or dispersed) in the water to form a first silicon precursor aqueous solution, thereby facilitating the subsequent hydrolysis step.

In the hydrolysis step, the silane compound of the first silicon precursor is hydrolyzed into a silanol compound and lower alcohols, and the silicate compound is hydrolyzed into a silicic acid and alkali metal ions or ammonium ions. Carbon numbers of the aforementioned lower alcohols depend on structures of the silane compound of the first silicon precursor.

In some embodiments, the hydrolysis step can be performed at a pH value of 2.5 to 4.0, and preferably 3.5 to 3.8. An acid catalyst was added to the first silicon precursor aqueous solution, for controlling the aforementioned pH value. The acid catalyst can include, but be not limited to, inorganic acids and lower organic acids. Specific examples of the inorganic acids can include hydrochloric acid and phosphoric acid, and specific examples of the lower acids can include formic acid, acetic acid and oxalic acid. When the hydrolysis step is performed at pH value of 2.5 to 4.0, it is beneficial for hydrolysis of the first silicon precursor to prevent hydrolyzed products (i.e. the first silanol compound described above) from undergoing a condensation, which causes the first silicon precursor hydrolyze incompletely, such that it is beneficial to produce the silicon-based gels with the three-dimensional network structure, thereby decreasing the thermal conductivity and the bulk density of the resulted silicon-based powders.

After the operation 110, a second silicon precursor aqueous solution is prepared, as shown in an operation 120. Because there is no difference in an order of the operation 110 and the operation 120, they can be performed simultaneously or sequentially. The second silicon precursor aqueous solution comprises the second silicon precursor and the diluted water. In some embodiments, the second silicon precursor can comprise one or more compounds having a structure shown as following formula (I):

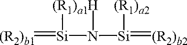

In the formula (I), R₁ is independently a hydrogen atom or an alkyl group having 1 to 4 carbons, R₂ is independently alkylene group having 1 to 4 carbons, and b1 and b2 are independently 0 or 1; when the b1 and the b2 both are 0, a1 and a2 both are 3; when the b1 and the b2 are 1, the a1 and the a2 both are 1.

The second silicon precursor has a secondary amino group and several alkyl groups, such that the second silicon precursor can slowly and continuously be hydrolyzed into ammonia water and a silanol compound (i.e. the aforementioned second silanol compound). The ammonia water can be used as a basic catalyst in subsequent condensation. During the condensation, the ammonia water is heavily diluted with the diluted water, for gradually increasing a pH value of a reaction system. Therefore, it is beneficial to form the silicon-based gels with the three-dimensional network structure, thereby decreasing the bulk density and the thermal conductivity coefficient of the resulted silicon-based powders.

The silanol compound described above can be used as a surface modifier of the silicon-based gels. One silanol group of the silanol compound can react with a silanol group on surfaces of the silicon-based gels to generate a siloxy group. Several hydrophobic alkyl groups of the silanol compound can enhance a hydrophobicity of the surfaces of the silicon-based gels to facilitate the removal of water inside pores in the three-dimensional network structure of the silicon-based gels. Therefore, integrity of the structure of the silicon-based gels can be retained, thereby decreasing the bulk density and the thermal conductivity coefficient of the resulted silicon-based powders.

In conventional methods for producing the silicon-based powders, the condensation is facilitated by directly adding a basic catalyst (i.e. ammonia water) with a fixed amount, such that the pH value of the reaction system immediately raises, which easily causes the condensation undergo vigorously to form thick dendrite or collapsed sheets, leading to an increase of the bulk density and the thermal conductivity coefficient of the silicon-based powders. Besides, the hydrophobicity of the conventional silicon-based gels is mainly resulted from the first silicon precursor, but the first silicon-based precursor only has one hydrophobic alkyl group, so the hydrophobicity of the silicon-based gels is poor.

In some embodiments, in the formula (I), when the b1 and the b2 both are 0 and the a1 and the a2 both are 3, more the hydrophobic alkyl group becomes, the higher hydrophobicity of the silicon-based gels can be. On the other embodiments, when the b1 and the b2 both are 1 and the a1 and the a2 both are 1, silicon-carbon double bond can provide a site for reaction, which facilitates production of the silicon-based powders with the three-dimensional network structure.

In some preferable specific examples, the second silicon precursor is one or more compounds selected from a group consisting of tetraalkyl disilazane and hexaalkyl disilazane. Specific examples of the hexaalkyl disilazane can include hexamethyl disilazane (HMDS). When the aforementioned second silicon precursor is used, because the second silicon precursor has more hydrophobic alkyl group, the hydrophobicity of the resulted silicon-based gels is further enhanced, and the bulk density and the thermal conductivity coefficient thereof are further decreased.

In some embodiments, a weight ratio of the first silicon precursor to the second silicon precursor is 1 : 0.005 to 1 : 0.05, preferably 1 : 0.01 to 1 : 0.03, and more preferably 1 : 0.015 to 1 : 0.02. When the weight ratio of the first silicon precursor to the second silicon precursor is in the aforementioned range, the silanol compound and ammonia water generated from hydrolysis of the second silicon precursor are enough to easily produce the silicon-based gels with the three-dimensional network structure and to completely modify the surfaces of the silicon-based gels. Therefore, the hydrophobicity of the resulted silicon-based gels is enhanced, and the bulk density and the thermal conductivity coefficient thereof are decreased.

In the method 100 for producing the silicon-based powders, the diluted water is used to prepare second silicon precursor aqueous solution. In some embodiments, a weight ratio of the diluted water to the first silicon precursor is more than 11. Preferably, the weight ratio can be 15 to 35, and more preferably can be 20 to 30. When the weight ratio of the diluted water to the first silicon precursor is in the aforementioned range, during condensation step, the sufficient diluted water can greatly dilute the first silicon precursor to produce the silicon-based gels with the three-dimensional network structure having the porosity, instead of silicon-based gels with dense and compact block structure. By the way, in the method 100 for producing the silicon-based powders, the subsequent condensation step is performed by using the second silicon precursor aqueous solution, and it is excluded to heat the second silicon precursor into gaseous second silicon precursor. The reason is that heating may cause decomposition or oxidation of the second silicon precursor.

After the operation 120, a condensation step is performed to the hydrolyzed solution and the second silicon precursor aqueous solution to obtain silicon-based gels, as shown in an operation 130. As mentioned above, the ammonia water generated from hydrolysis of the second silicon precursor in the second silicon precursor aqueous solution can facilitate the first silanol compound condense into polysiloxane to form the silicon-based gels with the three-dimensional network structure having a thin dendrite. The generated silanol compound (also referred to as second silanol compound) can further modify the surfaces of the silicon-based gels to enhance a hydrophobicity of the silicon-based gels, such that a contact angle of the resulted silicon-based powders is more than 140 °. Therefore, in the method 100 for producing the silicon-based powders of the present invention, the modification can be performed simultaneously to simplify process in the condensation step.

As mentioned above, the condensation of the first silanol compound and the hydrolysis of the product (i.e. the aforementioned polysiloxane) generated from the condensation of the first silanol compound can be affected by the pH value of the reaction system. In some embodiments, an initial pH value of the condensation step can be performed in a range of more than 7 and less than 8. In other words, the hydrolyzed solution and the second silicon precursor aqueous solution begin to mix with each, and as increasing of the second precursor participating in the hydrolysis, the pH value of the system slowly increases, which is better than the conventional method using ammonia water. In the conventional method, the ammonia water directly causes the pH value of the reaction system rapidly raise, which further results in the vigorous condensation. Therefore, silicon-based gels with a thick dendrite or collapsed sheets are formed, instead of the thick dendrite.

After the operation 130, a drying step is performed to the silicon-based gels to obtain the silicon-based powders, as shown in an operation 140. The drying step is used to remove solvents used before the drying step, and the solvents include the water inside the pores in the three-dimensional network structure of the silicon-based gels to obtain dried silicon-based powders. Since the surfaces of the silicon-based gels have a high hydrophobicity, it is beneficial to dry the solvents and water. Accordingly, the method 100 for producing the silicon-based powders of the present invention can simplify the conditions of the drying step.

In some embodiments, a pressure of the drying step can be 0.5 atm to 1.5 atm, and a drying temperature of the drying step can be 80° C. to 150° C. When the pressure and/or the drying temperature are in the aforementioned range, the water inside the pores in the structure of the silicon-based gels can easily be removed and the integrity of the structure can easily be retained. Therefore, the bulk density and the thermal conductivity of the resulted silicon-based powders are decreased. In some specific examples, the drying step can be performed by using drying devices, such as an oven, a fluid bed, a spray dryer and a microwave oven.

Another aspect of the present invention is to provide silicon-based powders, which is produced by the aforementioned method for producing the silicon-based powders. A thermal conductivity coefficient of the silicon-based powders is less than 0.035 W/m·K, and the bulk density of the silicon-based powders is less than 0.05 g/cm³. Therefore, the resulted silicon-based powders can be applied to hydrophobic thermal insulation material. Specific application examples of the thermal insulation material can include, but be not limited to, water-proof and thermal insulation blankets, hydrophobic fire-proof blankets and fire-fighting blankets. Preferably, the thermal conductivity coefficient of the silicon-based powders can be equal to 0.01 W/m·K to 0.035 W/m·K, and the bulk density of the silicon-based powders can be less than 0.045 g/cm³.

In some embodiments, a contact angle of the silicon-based powders is more than 140 °, and preferably equal to 140 ° to 150 °. When the bulk density of the silicon-based powders is in the aforementioned range, the resulted silicon-based powders further are suitable for the thermal insulation material, especially for production of cloth for thermal insulation cloth, thermal insulation blankets, and thermal insulation clothes and etc.

The following embodiments are used to illustrate the applications of the present invention, but they are not used to limit the present invention, it could be made various changes or modifications for a person having ordinary sill in the art without apart from the inspire and scope of the present invention.

### Production of Silicon-Based Powders

### Embodiment 1

In the embodiment 1, a hydrolysis step, a preparation step, a condensation step and a drying step were performed according to a context recited by following Table 1 to obtain the silicon-based powders of the embodiment 1, which was evaluated by the aftermentioned evaluation tests. 0.5 part by weight of cetyltrimethylammonium bromide was used as an emulsifier in the hydrolysis step, a usage of an acid catalyst was 6 parts by weight, and a solvent was 114 parts by weight of water. The hydrolysis step was performed at a pH value of 3.5 to 3.8. Besides, conditions of the drying step were 0.5 atm to 1.5 atm of pressure and 80° C. to 150° C. of drying temperature.

### Embodiments 2 to 4 and Comparative Embodiments 1 to 4

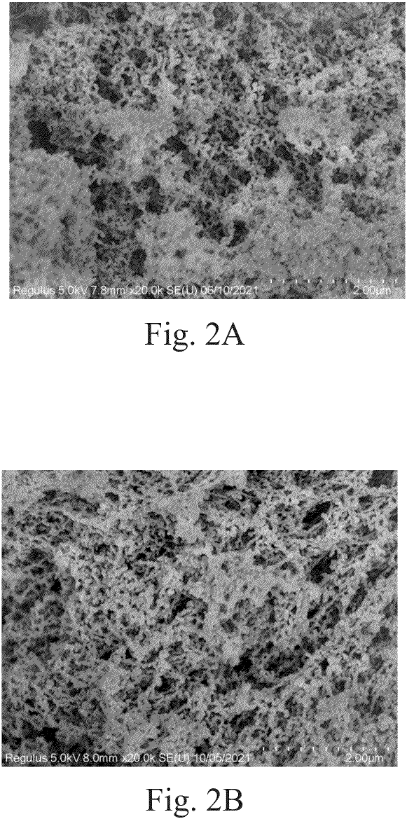

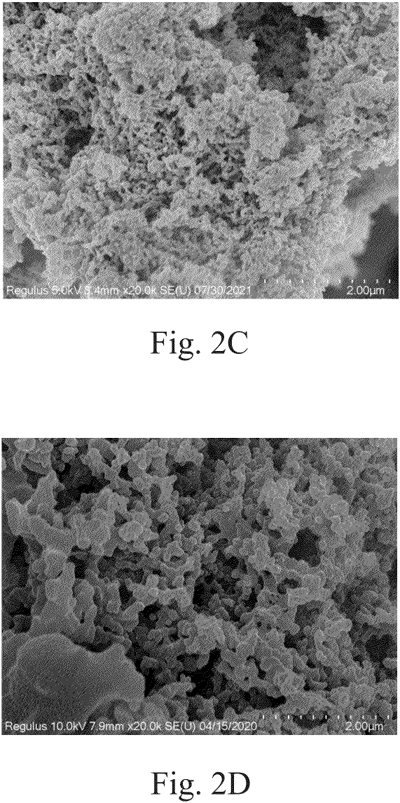

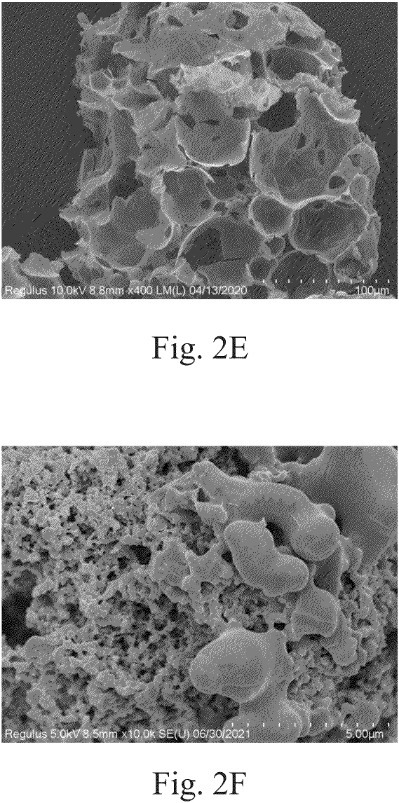

The embodiments 2 to 4 and the comparative embodiments 1 to 4 were practiced with the same method as in the embodiment 1 except the aftermentioned conditions. In embodiments 2 to 4 and the comparative embodiments 3 to 4, types of the acid catalyst, the weight ratio of the diluted water to the first silicon precursor, and the weight ratio of the first silicon precursor to the second silicon precursor were varied. In the comparative embodiments 1 to 2, the second silicon precursor was not used, but a basic catalyst was used. Further, in the comparative embodiment 2, the type of the solvent was varied. Specific conditions and evaluated results of embodiments 1 to 4 and comparative embodiments 1 to 4 were shown in Table 1 and FIGS. 2A to 2F.

### Evaluation Methods

### 1. Test for Thermal Conductivity Coefficient

In the test for the thermal conductivity coefficient, the thermal conductivity coefficient of the silicon-based powders was measured by a thermal conductivity analyzer accordingly to ISO 22007-2, in which conditions were 10 mW of power and 20 seconds or 80 seconds of detecting time. The measured thermal conductivity coefficient was used to evaluate a thermal conductivity of the silicon-based powders. When the thermal conductivity coefficient of the silicon-based powders is less than 0.036 W/m·K, the silicon-based powders have a good thermal insulating property.

### 2. Test for Contact Angle

The test for the contact angle was performed by a static contact angle meter according to ASTM C813, in which the silicon-based powders were placed and pasted on one surface of a double sided tape, and unpasted powders were removed to ensure a layer of powders uniformly pasted on the surface. Then, after the other surface of the double sided tape was pasted on a stage, a drop of water was dropped on the layer of powders, then a contact angle of the drop of water was measured, and the contact angle was used to evaluate a hydrophobicity of the silicon-based powders. When the contact angle was more than 140 °, the silicon-based powders have good hydrophobicity.

### 3. Test for Bulk Density

The test for the bulk density was performed according to ISO 60, in which a density of the silicon-based powders naturally packed by gravity was measured to evaluate a property exhibited by the packed silicon-based powders. The bulk density is also called as apparent density or loose density.

### 4. Test for Powder Morphology

In the test for the powder morphology, the morphology of the silicon-based powders was observed by a scanning electron microscopy to evaluate a microstructure of the silicon-based powders.

TABLE 1

| | | | | embodiment | | | |
|---|---|---|---|---|---|---|---|
| | | | | 1 | 2 | 3 | 4 |
| process conditions | hydrolysis step | first silicon precursor | type | methyltrimethoxysilane | | | |
| | | | weight (part by weight) | 100 | | | |
| | | acid catalyst | | aqueous phosphoric acid | aqueous hydrochloric acid | aqueous hydrochloric acid | aqueous hydrochloric acid |
| | preparing step | second silicon precursor | | hexamethyl disilazane | | | |
| | | weight ratio of water to first silicon precursor | | 22.6 | 22.6 | 22.6 | 22.6 |
| | | weight ratio of first silicon precursor to second silicon precursor | | 1:0.017 | 1:0.017 | 1:0.008 | 1:0.03 |
| | | solvent | | water | | | |
| | condensation step | initial pH value | | 7.2 | 7.2 | 7.3 | 7.28 |
| | | additive basic catalyst | | none | | | |
| evaluated results | silicon-based powders | thermal conductivity coefficient (W/m·K) | | 0.033 | 0.0328 | 0.0336 | 0.0338 |
| | | contact angle (°) | | 149 | 142 | >140 | 144 |
| | | bulk density (g/cm³) | | 0.038 | 0.041 | 0.048 | 0.048 |
| | | powder morphology | | 3D network thin dendrite | 3D network thin dendrite | 3D network thin dendrite | 3D network thin dendrite |

TABLE 1 (continued)

| | | | | comparative embodiment | | | | | | |
|---|---|---|---|---|---|---|---|---|---|---|
| | | | | 1 | | 2 | | 3 | | 4 |
| process conditions | hydrolysis step | first silicon precursor | type | methyltrimethoxysilane | | | | | | |
| | | | weight (part by weight) | 100 | | | | | | |
| | | acid catalyst | | aqueous phosphoric acid | aqueous phosphoric acid | | aqueous hydrochloric acid | | aqueous hydrochloric acid | |
| | preparing step | second silicon precursor | | none | | | hexamethyl disilazane | | | |
| | | weight ratio of water to first silicon precursor | | 22.6 | 22.6 | | 22 | | 11 | |
| | | weight ratio of first silicon precursor to second silicon precursor | | none | none | | 1:0.08 | | 1:0.017 | |
| | | solvent | | water | n-hexane | | water | | water | |
| | condensation step | Initial pH value | | 9 | 9.15 | | 7.2 | | 7.4 | |
| | | additive basic catalyst | | ammonia water | ammonia water | | none | | none | |
| evaluated results | silicon-based powders | thermal conductivity coefficient (W/m·K) | | 0.037 | 0.0370 | | 0.040 | | 0.0370 | |
| | | contact angle (^{·}) | | NA | 138 | | NA | | NA | |
| | | bulk density (g/cm³) | | 0.091 | 0.035 | | 0.092 | | 0.068 | |
| | | powder morphology | | coral structure thick dendrite | cracking sheet | | block structure thick dendrite | | 3D network thick dendrite | |

Concentrations of aqueous hydrochloric acid and aqueous phosphoric acid were 0.1 %.

Weights of the emulsifiers, the acid catalysts and the solvents were based on a weight of a first silicon precursor as 100 parts by weight.

NA presented that the test for the contact angle was not performed.

Referring to Table 1 and FIGS. 2A and 2D, in comparison with the comparative embodiment 1, hexamethyl disilazane was used in the embodiment 1, and ammonia water and trimethylsilanol generated by the hexamethyl disilazane can facilitate production of the silicon-based powders with a three-dimensional network structure, thereby decreasing the thermal conductivity coefficient and the bulk density of the silicon-based powders.

Next, referring to Table 1 and FIGS. 2A and 2E, in comparison with the comparative embodiment 2, the second silicon precursor aqueous solution was prepared with water in the embodiment 1, the resulted silicon-based powders had smaller thermal conductivity coefficient, and the powder morphology of the silicon-based powders was the three-dimensional network structure. Therefore, the second silicon precursor aqueous solution prepared with the water can facilitate production of the silicon-based powders with the three-dimensional network structure, thereby decreasing the thermal conductivity of the silicon-based powders.

In addition, referring to Table 1 and FIGS. 2B, 2C and 2F, in comparison with the comparative embodiment 3, the weight ratio of the first silicon precursor to the second silicon precursor was in an appropriate range of 1 : 0.005 to 1 : 0.05 in the embodiments 2 and 3, the silicon-based powders produced by the embodiments 2 and 3 had smaller thermal conductivity coefficient and bulk density, and the powder morphology of the silicon-based powders was the three-dimensional network structure. Therefore, the weight ratio of the two silicon precursor in the aforementioned range can facilitate production of the silicon-based powders with the three-dimensional network. Therefore, the thermal conductivity and the bulk density of the silicon-based powders were decreased.

Besides, referring to Table 1, in comparison with the comparative embodiment 4, the weight ratio of the water to the first silicon precursor was more than 11 in the embodiment 4, the resulted silicon-based powders had smaller thermal conductivity coefficient and bulk density, and the powder morphology of the silicon-based powders was the three-dimensional network structure having thicker dendrite. Thereof, sufficient water can facilitate production of the silicon-based powders with the three-dimensional network structure having the thicker dendrite, thereby decreasing the thermal conductivity and the bulk density of the silicon-based powders.

In summary, in an application of the silicon-based powders and the method for producing the silicon-based powders of the present invention, in which by using the specific silicon precursor having the secondary amino group and the alkyl groups and adjusting of the specific weight ratio of water to the silicon precursor having the alkoxy, in the method, the condensation can be performed without organic solvents and the modification is performed to the silicon-based gels to enhance the safety of the processes and the hydrophobicity of the resulted silicon-based powders, and decrease the thermal conductivity and the bulk density of the resulted silicon-based powders.

Although the present invention has been disclosed in several embodiments as above mentioned, these embodiments do not intend to limit the present invention. Various changes and modifications can be made by those of ordinary skills in the art of the present invention, without departing from the spirit and scope of the present invention. Therefore, the claimed scope of the present invention shall be defined by the appended claims.

What is claimed is:

1. A method for producing silicon-based powders, comprising:
performing a hydrolysis step to a first silicon precursor, an emulsifier and water to obtain a hydrolyzed solution;
performing a preparing step, wherein a silicon precursor aqueous solution is prepared, and the silicon precursor aqueous solution comprises a second silicon precursor and a diluted water;
performing a condensation step to the hydrolyzed solution and the silicon precursor aqueous solution to obtain silicon-based gels; and
performing a drying step to the silicon-based gels to obtain the silicon-based powders,
wherein all of the hydrolysis step, the preparing step and the condensation step exclude organic solvents.

2. The method for producing the silicon-based powders of claim 1, wherein the first silicon precursor comprises:
a silicate compound, wherein the silicate compound comprises silicate and/or ammonium silicate of alkali metals; and/or
a silane compound, wherein the silane compound comprises a methyl siloxane compound, and the methyl siloxane compound is one or more compounds selected from a group consisting of methyltrimethoxysilane, methyltriethoxysilane, dimethyldimethoxysilane, and dimethyldiethoxysilane.

3. The method for producing the silicon-based powders of claim 1, wherein based on a weight of the first silicon precursor as 100 parts by weight, a weight of the emulsifier is 0.1 part by weight to 1 part by weight.

4. The method for producing the silicon-based powders of claim 1, wherein the hydrolysis step is performed at a pH value of 2.5 to 4.0.

5. The method for producing the silicon-based powders of claim 1, wherein the second silicon precursor comprises one or more compounds having a structure shown as following formula (l): 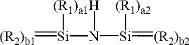
in the formula (l), R₁ is independently a hydrogen atom or an alkyl group having 1 to 4 carbons, R₂ independently is alkylene group having 1 to 4 carbons, and b1 and b2 are independently 0 or 1; when the b1 and the b2 both are 0, a1 and a2 both are 3; when the b1 and the b2 both are 1, the a1 and the a2 both are 1.

6. The method for producing the silicon-based powders of claim 5, wherein the second silicon precursor is one or more compounds selected from a group consisting of tetraalkyl disilazane and hexaalkyl disilazane.

7. The method for producing the silicon-based powders of claim 1, wherein a weight ratio of the first silicon precursor to the second silicon precursor is 1 : 0.005 to 1 : 0.05.

8. The method for producing the silicon-based powders of claim 1, wherein a weight ratio of the diluted water to the first silicon precursor is more than 11.

9. The method for producing the silicon-based powders of claim 1, wherein an initial pH value of the condensation step is more than 7 and less than 8.

10. The method for producing the silicon-based powders of claim 1, wherein a pressure of the drying step is 0.5 atm to 1.5 atm, and a drying temperature of the drying step is 80° C. to 150° C.

11. Silicon-based powders produced by a method for producing silicon-based powders of claim 1, wherein a thermal conductivity coefficient of the silicon-based powders is less than 0.035 W/m▪K, and a bulk density of the silicon-based powders is less than 0.05 g/cm³.

12. The silicon-based powders of claim 11, wherein a contact angle of the silicon-based powders is more than 140 °.

13. A method for producing silicon-based powders, comprising:
performing a hydrolysis step to a first silicon precursor, an emulsifier and water to obtain a hydrolyzed solution;
performing a preparing step, wherein a silicon precursor aqueous solution is prepared, and the silicon precursor aqueous solution comprises a second silicon precursor and a diluted water, wherein a weight ratio of the first silicon precursor to the second silicon precursor is 1 : 0.01 to 1 : 0.03;
performing a condensation step to the hydrolyzed solution and the silicon precursor aqueous solution to obtain silicon-based gels; and
performing a drying step to the silicon-based gels to obtain the silicon-based powders,
wherein all of the hydrolysis step, the preparing step and the condensation step exclude organic solvents.

14. The method for producing the silicon-based powders of claim 13, wherein the first silicon precursor comprises:
a silicate compound, wherein the silicate compound comprises silicate and/or ammonium silicate of alkali metals; and/or
a silane compound, wherein the silane compound comprises a methyl siloxane compound, and the methyl siloxane compound is one or more compounds selected from a group consisting of methyltrimethoxysilane, methyltriethoxysilane, dimethyldimethoxysilane, and dimethyldiethoxysilane.

15. The methoyd for producing the silicon-based powders of claim 13, wherein a weight ratio of the first silicon precursor to the second silicon precursor is 1 : 0.015 to 1 : 0.02.

16. The method for producing the silicon-based powders of claim 13, wherein the weight ratio of the diluted water to the first silicon precursor is 15 to 35.

17. The method for producing the silicon-based powders of claim 16, wherein the weight ratio of the diluted water to the first silicon precursor is 20 to 30.

18. The method for producing the silicon-based powders of claim 13, wherein the hydrolysis step is performed at the pH value of 3.5 to 3.8.

19. The method for producing the silicon-based powders of claim 13, wherein the second silicon precursor comprises one or more compounds having a structure shown as following formula (l): 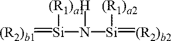
in the formula (l), R₁ is independently a hydrogen atom or an alkyl group having 1 to 4 carbons, R₂ independently is alkylene group having 1 to 4 carbons, and b1 and b2 are independently 0 or 1; when the b1 and the b2 both are 0, a1 and a2 both are 3; when the b1 and the b2 both are 1, the a1 and the a2 both are 1.

20. The silicon-based powders of claim 13, wherein the thermal conductivity coefficient of the silicon-based powders is equal to 0.01 W/m▪K to 0.035 W/m▪K, and the bulk density of the silicon-based powders is less than 0.45 g/cm³.
